(19) United States
(12) Patent Application Publication
(10) Pub. No.: US 2005/0200701 A1
(43) Pub. Date: Sep. 15, 2005

(54) Methods of converting monochromatic night vision or other electro-optical viewing devices to potray a full-color video image and video imaging apparatuses and devices embodying such methods

(76) Inventor: Peter W. J. Jones, Cambridge, MA (US)

Correspondence Address: EDWARDS & ANGELL, LLP, P.O. BOX 55874, BOSTON, MA, 02205, US

(21) Appl. No.: 10/507,795

(22) PCT Filed: Mar. 12, 2003
(86) PCT No.: PCT/US03/07880

§ 371 Date: Apr. 29, 2005

Related U.S. Application Data
(60) Provisional application No. 60/363,874, filed on Mar. 12, 2002.

(51) Int. Cl. H04N 5/33

(52) U.S. Cl. 348/168

(57) ABSTRACT

There is featured a video-imaging apparatus that includes an electro-optical viewing device including a plurality of filters selectively positioned at a light input end of the viewing device and a video imaging device positioned at a light output end of the viewing device, that outputs video signals corresponding to light coming from the light output end. Also included is a filter determining mechanism that determines which of the plurality of filters is disposed at the light input end for particular light coming from the light output end and that provides an output signal of the determined filter and a display device that processes the video signals and the output signal of the determined filter so that a color image is displayed on a display of the display device.

This application claims the benefit of U.S. Provisional Application Ser. No. 60/363,874 filed Mar. 12, 2002, the teaching of which are incorporated herein by reference.

### FIELD OF INVENTION

This invention relates generally to techniques/methods for converting a monochromatic night vision device or other electro-optical device to produce a full-color output, more particularly to techniques/methods for producing a full-color video image using video imaging apparatuses and devices including a monochromatic night vision device or other electro-optical device, as well as video-imaging apparatuses- and devices embodying such techniques/methods.

### BACKGROUND OF THE INVENTION

The vast majority of night vision devices have a monochromatic output They typically work by using a lens to focus light from a scene onto the front of a sensor or image intensifier tube. The image is amplified and finally output on a phosphor display screen. While night vision (NV) is itself a great enhancement of normal human vision, it is sometimes desirable to have a NV device with a full-color output, for example to better differentiate an object one is searching for from its background: environment.

At present, typical methods of achieving a full-color NV device have been by the use of an especially sensitive and highly amplified CCD device (television camera). Alternatively, by the use of three separate image intensifier tubes, selected or filtered so as to be sensitive to the red, green and blue portions of the spectrum. The outputs of these three tubes are then fussed by the use of partially silvered prisms or mirrors or by integrating them in an interlaced red, green and blue (RGB) television-type display tube.

Among the disadvantages of these techniques are higher power usage, added weight, increased optical complexity compared to a simple image intensifier NV device, and susceptibility to being knocked out of alignment In addition, CCD devices are not effective image intensifiers and thus limit the light amplification possible. Note also that many night vision devices are designed to be mind on the user's head, a position where excess weight can be a problem. In addition, there is a vast installed base of monochromatic NV systems.

In addition to night vision devices that enhance normal human vision, video systems have been developed for night surveillance purposes. As with night vision devices, such night surveillance video systems have been generally configured and arranged so as to provide an intensified black and white image. Attempts have been made to provide video systems that are capable of providing a full-color image, however, these attempts have seen limited success.

There is described in International Application No. PCT/US01/05866, which is owned by the assignee of the present invention and whose teachings are incorporated herein by reference, methods of converting monochromatic night vision or other electro-optical viewing devices to portray a full-color image. The techniques and/or methods described therein yield night vision devices or other electrode-optical viewing devices that convert a monochromatic image so as to portray a full-color image and that avoid prior art shortcomings of higher power usage and increased optical complexity. The described methods or techniques, however, do not include specific teachings or directions for night video surveillance applications.

Accordingly, it is highly desirable to devise a simple and low-cost technique whereby a video surveillance apparatus, device or system embodying a monochromatic-output NV system is capable of providing a full-color output.

### SUMMARY OF INVENTION

In accordance with one aspect of the present invention, there is featured a structure comprising a rotating or oscillating axle shaft that is mounted parallel to the optical axis of a night vision (NV) device. A disk (filter wheel) mounting one or more filters, or one or more filters and open apertures, is fixed to the front end of the axle so that the filter(s) and aperture(s) will pass in front of the imaging sensor (forward of or behind the objective lens). At the rear of the NV device a second filter wheel is fixed to the axle, such that when a certain section of the forward filter wheel is positioned in front of the optical device's sensor, a corresponding section of the second filter wheel is positioned behind the eyepiece lens or screen of the NV device. The axle is spun or oscillated manually or by means of a small motor.

In this way, in a lightweight and uncomplicated manner, the filtration of incoming image-forming light is synchronized with the filtration of the amplified output image. The axle is spun or oscillated at a rate such that the switching between filter and open aperture or between different filters is faster than the eye's flicker rate and the viewer sees a merging of the different color images, producing the impression of viewing a full-color scene.

There are several strategies possible for the selection of the filters for the invention. One would be to use three color separation filters in the front filter wheel: red, green and blue. Red, green and blue filters would also be used correspondingly in the rear filter wheel, so that when the sensor was being exposed to only red light, the display would be filtered to give a red output, and likewise green for green and blue for blue. If the filter wheels switch at a rapid enough rate, the viewer will see a full-color scene. Note that with this strategy, the output phosphors have to give off red, green and blue light.

Other, simpler filter configurations are possible. Considering the discoveries of Dr. Edwin Land et al on the Retinex theory of color vision, the perception of a full color output is possible when viewing an output with only two quite narrow-band colors. Thus, other filtration strategies are possible.

For example, if the front filter wheel has an open aperture corresponding to an open aperture on the rear filter wheel, and a low-pass filter corresponding to a red filter on the rear filter wheel, the device output will be perceived as being full color (by this we mean that in the output image, colors have the correct “names”). In this example, the NV device's output phosphors would need to have red and non-red shorter-wavelength output (yellow, green; blue, etc).

If one desires to have an output that is perceived as full-color while using a phosphor screen that is only of a green color, then one strategy would be to have a front filter wheel with a high-pass filter and a low-pass filter and a rear filter wheel with corresponding high-pass green and low-pass green filters. Although the output will be muted in its perceived full-color scheme, the colors will have the correct “names.”

Alternatively, the front filter wheel could have an open aperture and low-pass filter corresponding to a rear filter wheel with a high-pass green and low-pass green filter.

Again, alternatively, the front filter wheel could have, a high-pass filter and an open aperture corresponding to a rear filter wheel with a high-pass green and low-pass green filter. In these cases above, the rear filter wheel could also have an open aperture combined with a high-band or high pass filter. Alternatively, the rear filter wheel could have an open aperture combined with a low-band or low-pass filter. What is important is to have an output that gives different lightness values for different. “color” objects in the image when they are perceived by the different kinds of receptors in the retina.

According to Retinex theory, the comparative lightness values of a surface as perceived by the different spectrally sensitive receptors in the retina are what we use to determine that surface's “color.” Many night vision devices have extended sensitivity into the near infrared spectrum. Since foliage has a high “lightness” value in the infrared range, with certain filtration strategies mentioned above foliage could be perceived as reddish brown rather than green in color. Different strategies in the selection of the filters could be used to adjust this or other important colors. For example, color perception of foliage seen through the system could be shifted back to a “green” color by combining a high-pass IR filter with a low-pass visible light (red) filter on the front filter wheel. In this way the lightness of the foliage in the combined red-IR range would be reduced.

In order for the different color images coming to the user's eye to fuse, the filter wheels need to be spun or oscillated fast enough so that the filter sections pass the eye faster than the eye's flicker rate (generally over 20 cycles/second). One technique to speed up the filter cycle rate without an excessive axle rate would be to put multiple sequences of the filters on each wheel.

According to another aspect of the present invention, there is featured a video-imaging apparatus that is configured and arranged so as to provide a full-color image to the viewer of the video image. Such an apparatus includes an electro-optical viewing device or a night vision device as is known to those skilled in the art, a disk or filter wheel that is rotatably mounted, a filter wheel position determining device or mechanism, a video image device and a control device operably coupled to the video-imaging device so as to relate the image signals being outputted by the video image device to a portion of the filter wheel. In a particular embodiment, the filter wheel is mounted upon a rotating or oscillating shaft or axle that is mounted parallel to the optical axis of the electro-optical viewing/night vision (NV) device.

The filter wheel is configured so as to include one or more filters, or one or more filters and open apertures, that is located so that the filter(s) and aperture(s) will pass in front of the imaging sensor of the electro-optical viewing/NV device. In more particular embodiments, the video-imaging apparatus further includes a lens assembly or an objective lens that is disposed between the electro-optical viewing/NV device and the object or scene being be viewed, which lens assembly or objective lens is configured and arranged so as to focus light from the object or scene being viewed on to the front of the sensor or image intensifier tube of the electro-optical viewing/NV device. In such embodiment, the filter wheel is disposed forward of or behind the lens assembly or objective lens.

The filter wheel position determining device or mechanism is any one of a number of devices known in the art, by which a rotational position of the filter wheel can be determined and a signal outputted that is representative of the determined rotational position. More particularly, the filter wheel position determining device or mechanism is configured and arranged so as to provide an output signal that provides an indication as to which filter is disposed between the object or scene being viewed and the electro-optical viewing/NV device.

In further embodiments, the video-imaging apparatus further includes a motor operably coupled to the axle so as to cause the axle and thus, the filter wheel to rotate at a predetermined rate or rotational speed. In more specific embodiments, the filter wheel position determining device or mechanism is operably coupled to the motor and/or the axle.

The video imaging device is disposed so the image sensing portion of the device views the display screen or output imaging portion of the electro-optical viewing/NV device. In this way, the amplified and outputted image from the electro-optical viewing/NV device is provided to the image sensing portion of the video imaging device. The video imaging device is any of a number of devices, including but not limited to CCD devices, video cameras, camcorders or other optical sensing devices known to those skilled in the art that can provide continuously, time sequenced output signals that are representative of the scene or image being viewed by the video imaging device.

The video imaging device and the filter wheel position determining device are each operably coupled to the control device. The control device receives the video signals from the video imaging device and relates the received video signals to the particular portion of the filter wheel that is disposed between the electro-optical viewing/NV device and the object or scene being viewed at the time of the generation of these video signals. In this way, the differently filtered video signals can be appropriately integrated and shown on a television-type of display tube so as to yield a full-color image. The control device is any and a number of circuits and/or microprocessors known to those skilled in the art that can receive and process the video signals and the signals from the filter wheel position determining device so as to accomplish the foregoing. In more specific embodiments, the video-imaging apparatus includes a display device as is known to those skilled in the art, that displays the video images of the object or scene being viewed.

Other aspects and embodiments of the invention are discussed below.

### BRIEF DESCRIPTION OF THE DRAWINGS

For a fuller understanding of the nature and desired objects of the present invention, reference is made to the following detailed description taken in conjunction with the accompanying drawing figures wherein like reference character denote corresponding parts throughout the several views and wherein:

FIG. 1 depicts a cut-away view of a typical night vision device with its subject and intensified image;

FIG. 2 depicts diagrammatically a particular embodiment of a structure in accordance with the invention, with a forward three-filter wheel and a rear three-filter wheel fixed to an ae that lies parallel to the optical axis of a NV device;

FIG. 3 depicts a side view of a particular embodiment of a structure in accordance with the invention, where an axle and motor are mounted to a NV device and where a forward three-filter wheel and a rear three-filter wheel are fixed to the axle. The axle is orientated so that it lies parallel to the optical axis of the NV device;

FIG. 4 depicts a view of the filter wheel of a particular embodiment of a structure in accordance with the invention, where the wheel contains three filter sections;

FIG. 5 depicts a view of the filter wheel of a particular embodiment of a structure in accordance with the invention, where the wheel contains two filter sections;

FIG. 6 depicts a view of the filter wheel of a particular embodiment of a structure in accordance with the invention, where the wheel contains one filter section and an open aperture;

FIG. 7 depicts a view of the filter wheel of a particular embodiment of a structure in accordance with the invention, where the wheel contains two filter sections and an open aperture;

FIG. 8 depicts a view of the filter wheel of a particular embodiment of a structure in accordance with the invention, where the wheel contains two filter and an open aperture, each of which are divided into two separate sections;

FIG. 9 is a diagrammatic view of a video-imaging apparatus according to a second aspect of the present invention with the subject being viewed and the intensified image of the electro-optical viewing/night vision device;

FIG. 10 is a side view of the video-imaging apparatus of FIG. 9;

FIG. 11 is a side view of a portion of a video-imaging apparatus according to another embodiment of the present invention.

FIGS. 12A,B are each a front view of a filter wheel illustrating filter wheels with differently proportioned filters; and

FIG. 13 is a diagrammatic view of a display portion of a video-imaging apparatus of the present invention.

### DESCRIPTION OF THE PREFERRED EMBODIMENTS

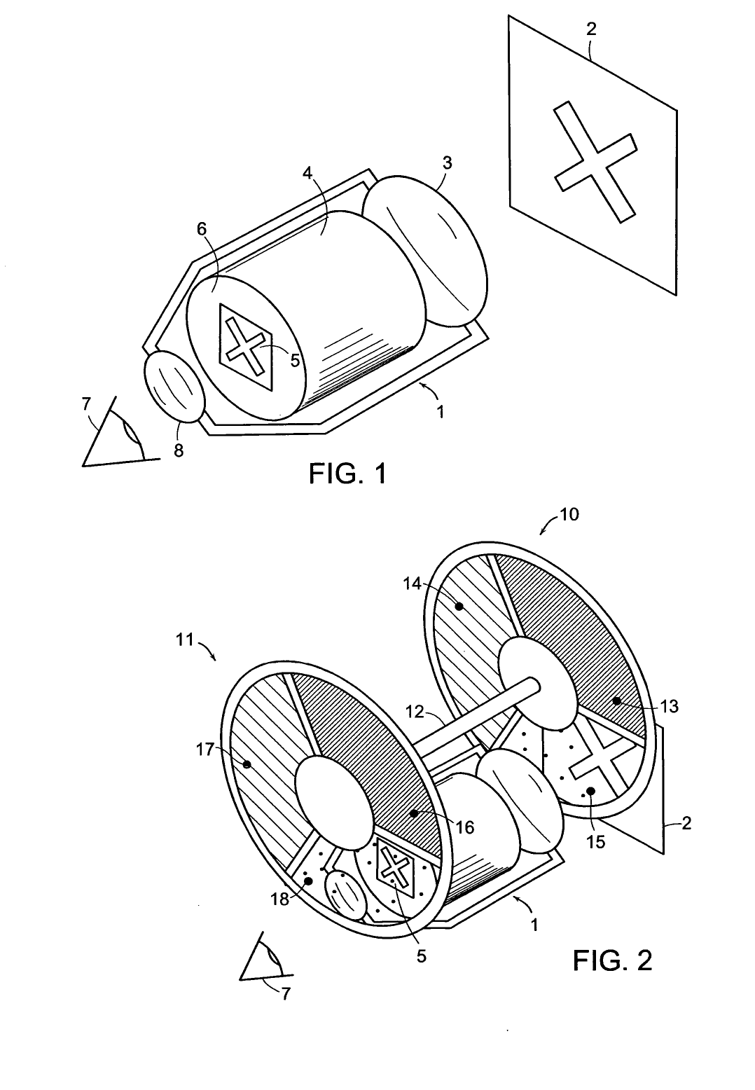

Referring now to the various figures of the drawing wherein like reference characters refer to like parts, there is shown in FIG. 1 a typical night vision (NV) device 1, where light from a subject 2 is thus focused by an objective lens 3 onto the front of an image intensifier tube 4. The amplified image 5 is displayed on a phosphor screen 6 where the user 7 can view it through the eyepiece lens 8.

Now referring to FIG. 2 there is shown diagrammatically one particular embodiment of a structure in accordance with the present invention for a method of converting monochromatic night vision or other electro-optical viewing devices to portray a full-color image. In accordance with the present invention, the structure includes a rotating or oscillating shaft or axle 12 that is mounted parallel to the optical axis of a night vision (NV) device 1. The axle 12 is spun or oscillated using any of a number of techniques known to those skilled in the art including manually or by means of a small motor. More particularly, the axle 12 is spun oscillated at a rate so that the filter sections of the filter wheels 10,11 pass the eye faster than the eye's flicker rate (generally over 20 cycles/second) such that the different color images coming to the user's eye fuse or merge. Stated another way; the axle 12 is spun or oscillated at a rate such that the switching between filter and open aperture or between different filters is faster enough that the viewer sees a merging of the different color images, producing the impression of viewing a full-color scene. Another technique for speeding up the filter cycle rate without an excessive axle rate is configuring the filter wheels 10, 11 so as to have multiple sequences of filters on each wheel.

A disk or filter wheel 10 mounting one or more filters, or one or more filters and open apertures, is fixed to the front end of the axle 12 so that the filter(s) and aperture(s) will pass in front of the imaging sensor of the night division (NV) device 1. This filter wheel also can be arranged so as to pass forward of or behind the objective lens 3. At the rear of the NV device 1 there is located a second filter wheel 11 that is fixed to the axle 12, such that when a certain section of the forward filter wheel 10 is positioned in front of the optical device's sensor, a corresponding section of the second filter wheel 11 is positioned behind the eyepiece lens or screen of the NV device. In this manner and when each of the filter wheels 10, 11 comprises three filters (a red, green and blue filter), when the red filter section 13 of the forward wheel is positioned in front of the night vision device, the red filter section 16 of the rear wheel in positioned between the user 7 and the output image 5. Likewise, when green filter 14 is in front of the device, green filter 17 will be positioned between the viewer and the output image, and when blue filter 15 is positioned in front of the device, blue filter 18 will be positioned between the viewer and the output image. When using a filter wheel comprising such three filters, the output phosphors should have to give off red, green and blue light.

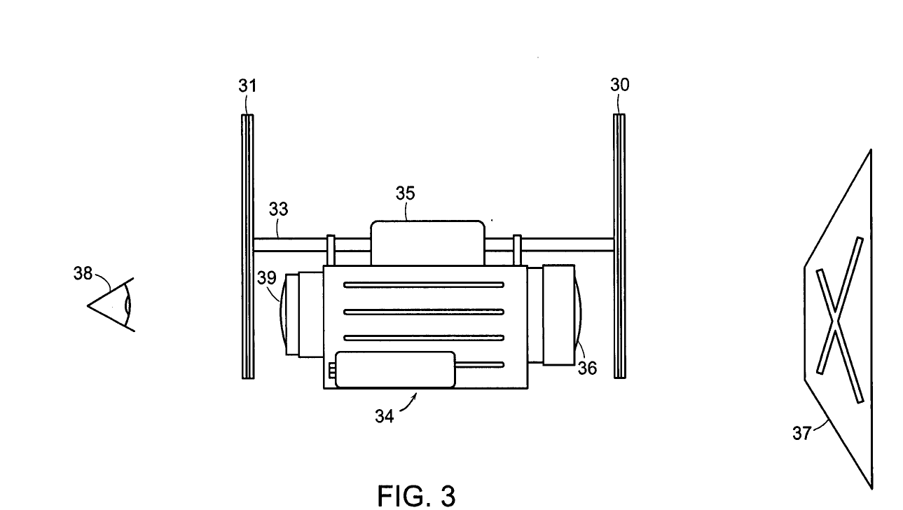

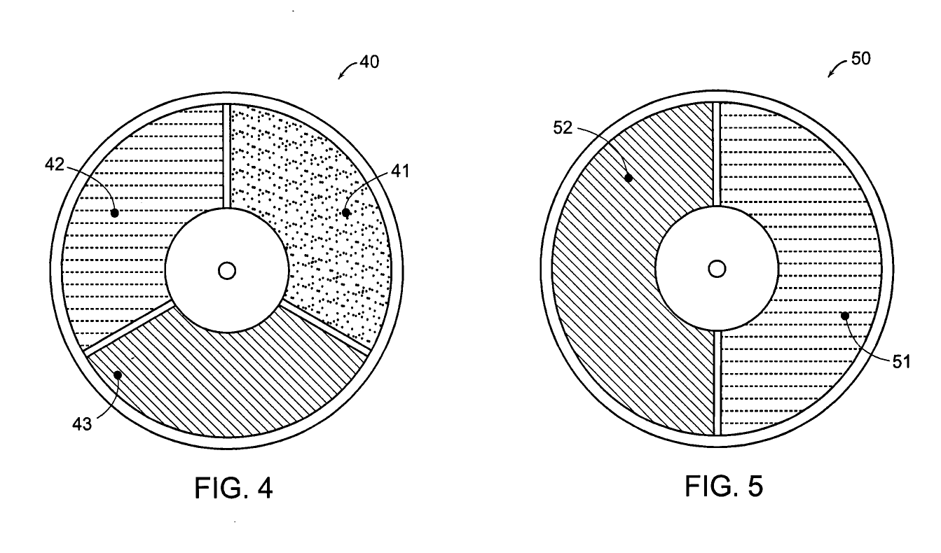

Now referring to FIG. 3, there is shown a side view of another particular embodiment of a structure in accordance with the invention where the front filter wheel 30 and the rear filter wheel 31 are fixed on an axle 33 that is mounted to a night vision device 34. A motor 35 is connected to the axle 33 so as to spin it, more particularly spin the axle at a desired rotational speed or rate. As can be seen, with this arrangement the objective lens 36 of the NV device views the subject 37 through a specific section of the front filter wheel 30 while the user 38 views the output 39 of the NV device 34 through a specific section of the rear filter wheel 31.

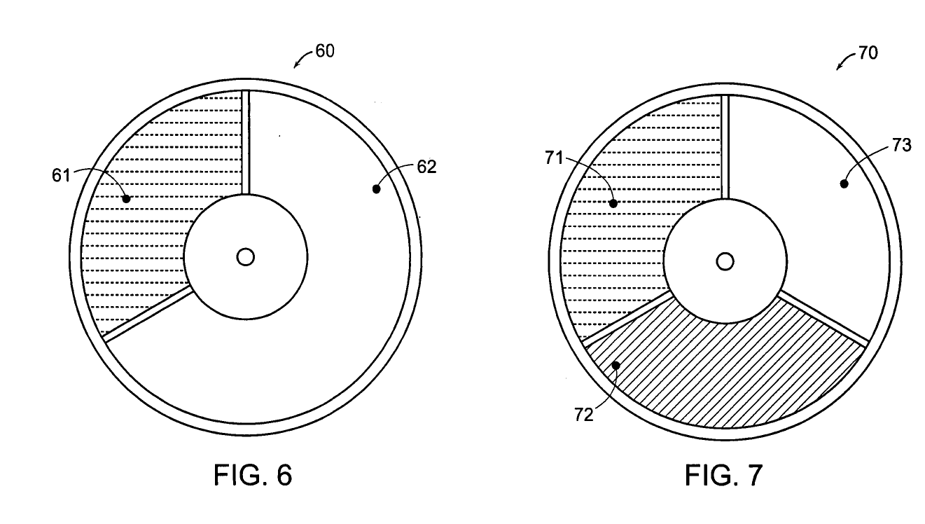

There is shown in FIG. 4, one embodiment of a filter wheel 40 that includes three different filters 41, 42 and 43 mounted on it so that as the wheel is spun, the three filters will pass in sequence in front of the sensor or behind the display of the optical device. Now referring to FIG. 5, there is shows an alternate embodiment of a filter wheel 50 that includes two different filters 51 and 52 mounted on it so that as the wheel is spun, the two filters will pass in sequence in front of the sensor or behind the display of the optical device.

Now referring to FIG; 6, there is shown another alternate embodiment of a filter wheel 60 that includes one filter 61 mounted on it and an open aperture 62. As the wheel is spun, the filter and the open aperture will pass in sequence in front of the sensor or behind the display of the optical device. There is shown in FIG. 7, yet another alternate embodiment of a filter wheel 70 that includes two filters 71 and 72 mounted on it and an open aperture 73. As the wheel is spun, the filters and the open aperture will pass in sequence in front of the sensor or behind the display of the optical device.

Now referring to FIG. 8, there is shown a further alternate embodiment of a filter wheel 80 that includes two sequences of filter/apertures. That is, each sequence has two open apertures 81, two filters of one type 82 and two filters of another type 83. These form two filter/aperture sequences 84 and 85. The wheel can therefore be spun at one-half the rotational rate of a single sequence filter wheel while maintaining the same flicker rate. The number of filter or filter aperture sequences can be selected for each front/rear wheel set to meet design needs.

The foregoing describes several strategies possible for the selection of the filters for the invention so that the viewer will see a full-color scene. The present invention, however, shall not be limited to the foregoing illustrative filter embodiments, as other filter configurations are contemplated for use in the present invention. For example, and considering the discoveries of Dr. Edwin Land et at on the Retinex theory of color vision, the perception of a full color output is possible when viewing an output with only two quite narrow-band colors. According to the Retinex theory, the comparative lightness values of a surface as perceived by the different spectrally sensitive receptors in the retina are what we use to determine that surface's “color.”

For example, if the front filter wheel has an open aperture corresponding to an open aperture on the rear filter wheel, and a low-pass filter corresponding to a red filter on the rear filter-wheel, the device output will be perceived as being fen color (by this we mean that in the output image, colors have the correct “names”). In this example, the NV, device's output phosphors would need to have red and non-red shorter wavelength output (yellow, green, blue, etc).

If one desires to have an output that is perceived as full-color while using a phosphor screen that is only of a green-color, then-one strategy would be to have a front filter wheel with a high-pass filter- and a low-pass filter and at rear filter wheel with corresponding high-pass green and low-pass green filters. Although the output will be muted in its perceived full-color scheme, the colors will have the correct “names.”

Alternatively, the front filter wheel could have an open aperture and low-pass filter corresponding to a rear filter wheel with a high-pass green and low-pass green filter. Again, alternatively, the front filter wheel could have a high-pass filter and an open aperture corresponding to a rear filter wheel with a high-pass green and low-pass green filter. In these cases above, the rear filter wheel could also have an open aperture combined with a high-band or high pass filter. Alternatively, the rear filter wheel could have an open aperture combined with a low-band or low-pass filter. What is important is to have an output that gives different lightness values for different “color” objects in the image when they are perceived by the different kinds of receptors in the retina.

Many night vision devices have extended sensitivity into the near infrared spectrum. Because foliage has a high “lightness” value in the infrared range, with certain filtration strategies mentioned above foliage could be perceived as reddish brown rather than green in color. Different strategies in the selection of the filters could be used to adjust this or other important colors. For example, color perception of foliage seen through the system could be shifted back to a “green” color by combining a high-pass IR filter with a low-pass visible light (red) filter on the front filter wheel. In this way the lightness of the foliage in the combined red-IR range would be reduced.

Structures in accordance with the invention can be relatively easily fabricated for mounting on many different of night vision and other monochromatic electro-optical devices.

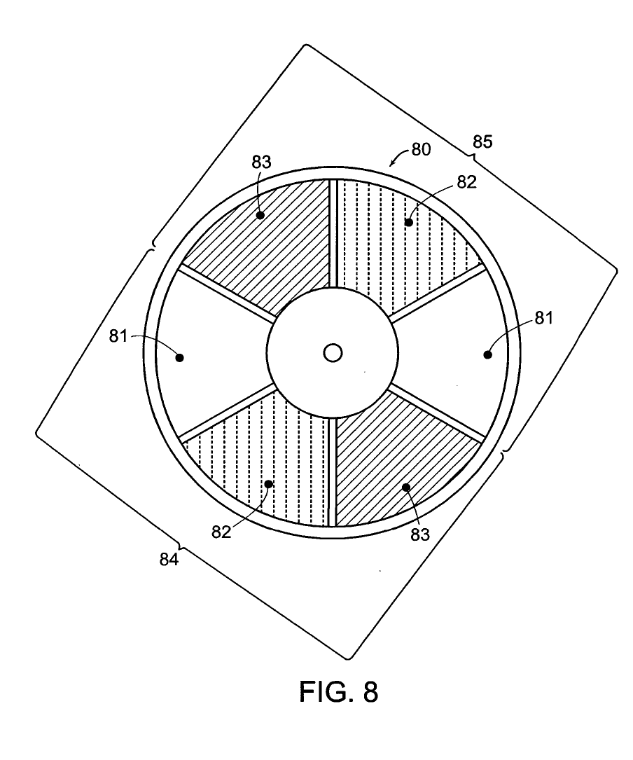

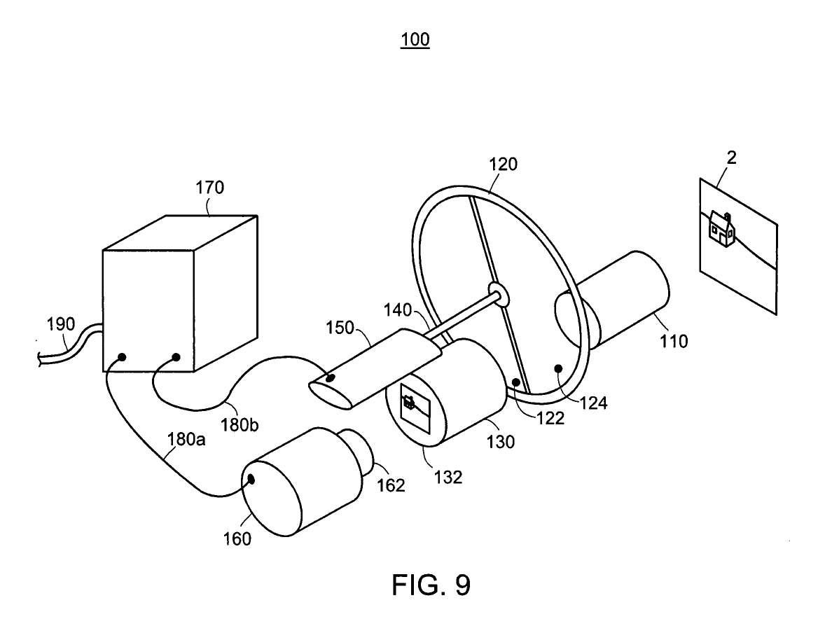

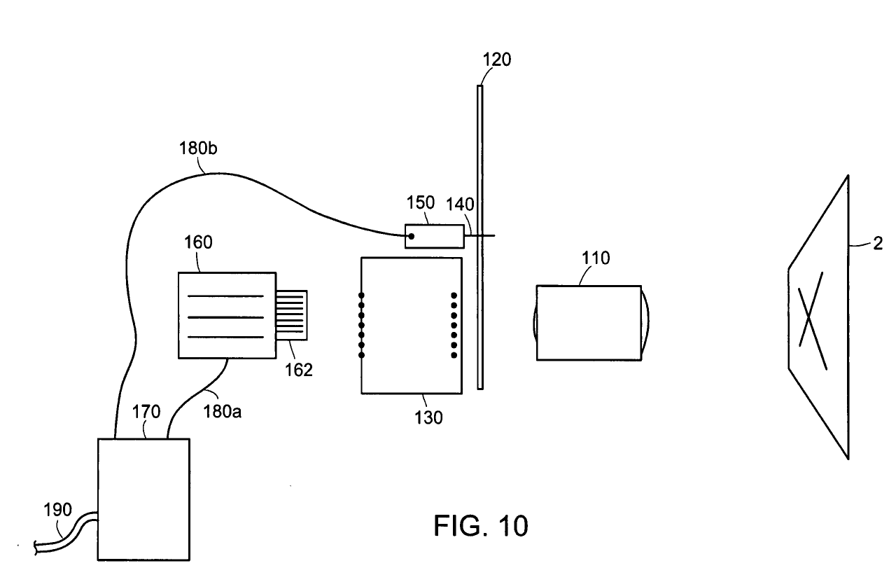

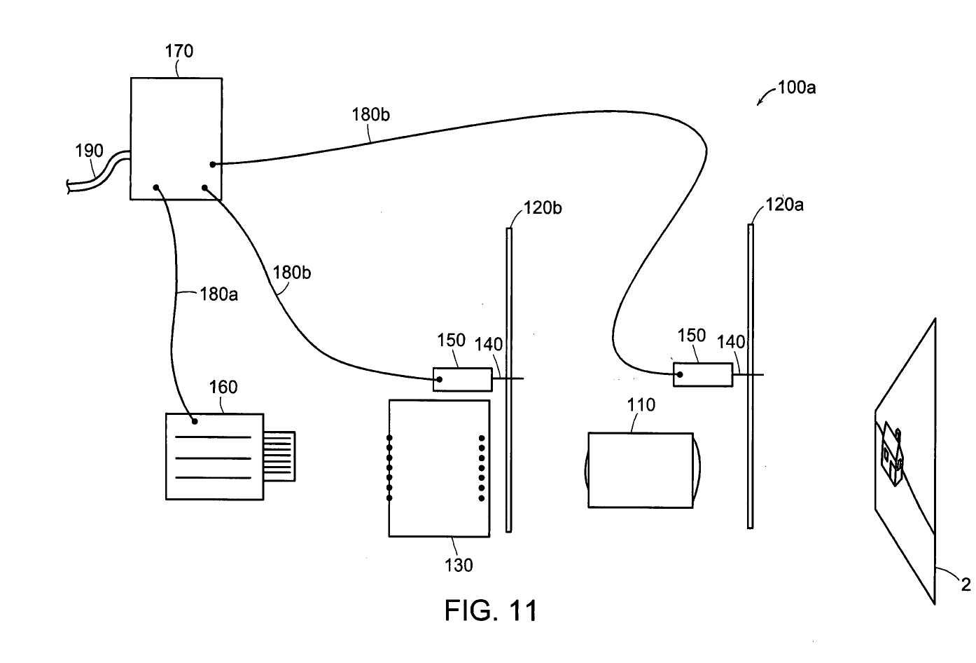

Now referring to FIGS. 9-10, there is shown various views of an embodiment of a video-imaging apparatus 100 according to the present invention that includes a optics or lens assembly 10, a filter wheel 120, a night vision device 130, an axle 140, a drive motor and filter position determining device 150, a video imaging device 160, a signal control device 170, inputting cables 180a,b and an output cable 190. Reference shall be made to the foregoing discussion regarding FIGS. 2-8 for further details regarding the filter wheel, axle and the lens assembly not otherwise provided hereinafter. The video imaging device 160 is any of the number of devices known to those skilled in the art that can continuously provide output signals representative of the viewed image, including but not limited to CCD devices such as a television camera and camcorders, or other devices employing an image intensifying tube.

The filter wheel 120 is located between the object or scene 2 and the sensor or image intensifier tube of the night vision device 130. In the illustrative embodiment, the filter wheel 120 is disposed between the lens assembly 110 and the night vision device 130. However, and as described above, the filter wheel 120 can be disposed between the lens assembly 110 and the object or scene 2 being viewed.

As with the discussion above, the filter wheel 120 includes one or more filters, more particularly two or more filters, each filter having a predetermined band pass so as to selectively and differently filter the incoming light from the object or scene 2 being viewed. In an exemplary illustrative embodiment, the filter wheel 120 includes two filters, a high pass filter 122 and a low pass filter 124. The high pass filter 122 is composed so as to filter the incoming light from the object or scene 2 in a band pass different from that of the low pass filter 124. For example, the high pass filter 122 can be composed so as to be a blue or green color filter and the low pass filter 124 can be composed so as to be a red color filter. The foregoing is illustrative and not limiting, as it is within the scope of the present invention for other filtering schemes or filtering strategies to be implemented their otherwise consistent with the operation and use of the present invention.

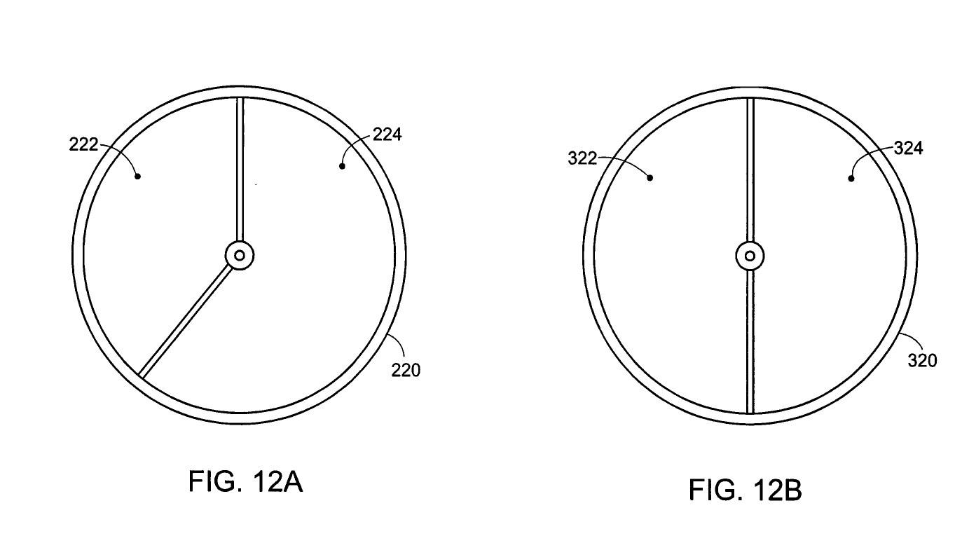

Further and with reference to FIGS. 12A,B, the filter wheel for a given application can embody differently sized or proportioned filters. For example, and as shown in FIG. 12A, a filter wheel 220 can include a band pass filter 222 that encompasses approximately one-third the circumference or area of the filter wheel and a second band pass filter 224 that encompasses approximately two-thirds the circumference or area of the filter wheel. In another exemplary embodiment, a filter wheel 320 is configured so one band pass filter 322 encompasses approximately one-half the circumference or area of the filter wheel and the second band pass filter 324 encompasses the other half of the circumference or area of the filter wheel.

Referring back to FIG. 9, and as also discussed above, the filter wheel 120 is mounted on the axle 140 so the filter wheel can rotate so as to sequentially and repeatedly pass each of the filters 122, 124 or filter sections in front of the sensor or image intensifier tube of the night vision device 130 thereby selectively, sequentially and repeatedly filtering the incoming light from the object or scene 2. The filter wheel 120 is rotated such that each of the filters passes in front of the night vision device 130 so that the image being displayed does not appear to flicker.

The drive motor and filter position determining device 150 includes a motor, such as a fractional horsepower electrical motor, that is operably coupled to the axle 140 using any of a number of techniques known to those skilled in the art (e.g. gears) so the motor causes the axle to rotate in a predetermined direction and at a predetermined rotational speed. The drive motor and filter position determining device 150 also includes a mechanism or device that is operably coupled to the motor or the axle 140 using any of the number of techniques known to those skilled in the art so that one or more signals can be outputted representative of the rotational position of a given filter or filter section of the filter wheel 120. For example, such a mechanism, device or signal generator can include a wheel that is secured to the axle 140, which wheel includes a plurality of equidistant radial through apertures in the sides of the wheel and a light source and a photo-eye. The light source is arranged on one side of the wheel so the light beam is selectively passed through the radial slots and blocked by the side of the wheel as it rotates. The photo-eye is disposed on the other side of the wheel to detect the light pulses and, correspondingly, provide a pulsed signal output. The pulsed outputs in tam can be related to the rotation of the filter wheel 120 and thus to the rotational position of each filter 122, 124 or filter section of the filter wheel.

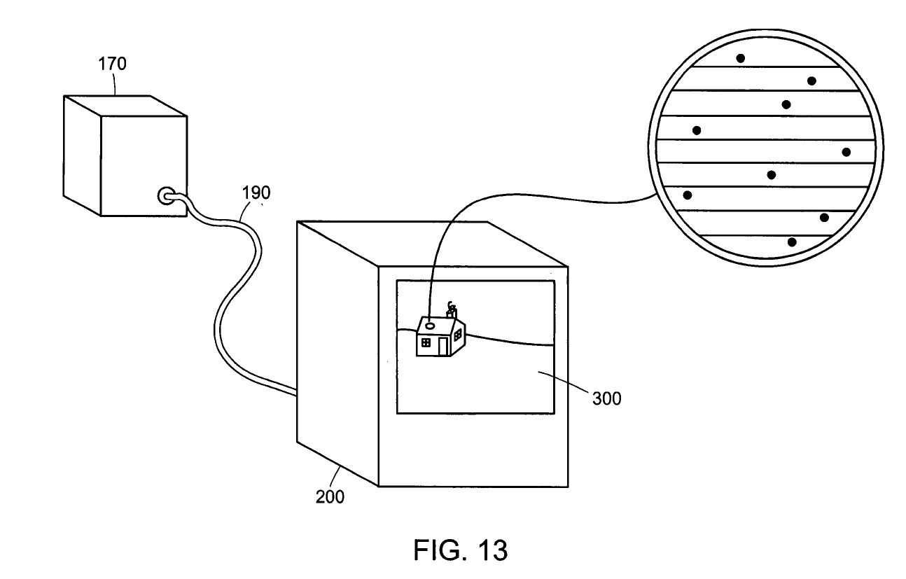

The video imaging device 160 and the filter wheel position determining mechanism of the drive motor and filter position determining device 10 are each operably coupled to the control device 170. The control device 170 receives the video signals from the video imaging device 160 via one cable 180a and receives one or more position signals via a second cable 180b. The control device 170 processes these one or more position signals being received to determine which filter 122, 124 or filter section is passing in front of the night vision device 130 for the intensified light image that is being viewed by the video imaging device 160. Stated another way, the control device 170 determines which filter 122, 124 or filter section of the filter wheel 120 is filtering the incoming light from the scene 2 that relates to the video signals being received by the control device. The control device 170 relates all of the video, signals being received to each of the filter 122, 124 or filter sections of the filter wheel 120 so as to allow the video signals of the different color filters to be integrated or merged in an interlaced RGB television-tight display tube 200 (FIG. 13). The control device 170 includes, any of the number of circuits and/or microprocessors known to those skilled in the art that perform the foregoing video signal accumulation, processing and integration, as well as relating the received video signals to the corresponding color filter.

Referring now to FIG. 11, there is shown a side view of a portion of the video imaging apparatus 100a according to another embodiment of the present invention that includes a optics or lens assembly 110, two filter wheels 120a,b, a night vision device 130, two axles 140, two drive motor and filter position determining devices 150, a video imaging device 160, a signal control device 170, inputting cables 180a, b and an output cable 190. Reference shall be made to the foregoing discussion regarding FIGS. 9-10 for further details and discussion regarding the a optics or lens assembly 110, the filter wheels 120a,b, the night vision device 130, the axles 140, the drive motor and filter position determining devices 150, the video imaging device 160, the signal control device 170, and the inputting cables 180a, b and the output cable 190 not otherwise described and discussed hereinafter.

In the illustrated embodiment, the video imaging apparatus 100a includes a front filter wheel 120a and a back filter wheel 120b. The front filter wheel 120a is located in front of the lens assembly 110 so as to be disposed between the object or scene 2 being viewed and the lens assembly. The back filter wheel 120b is located behind the lens assembly 110 so as to be disposed between the lens assembly and the night vision device 130. The front and back filter wheels 120a,b are each secured to an axle 140 that in turn is connected to one of the drive motor and filter wheel position determining devices 150. In this way, the front and back filter wheels are each rotated by the motor of the corresponding drive motor and filter position determining device 150. Also, the rotational position on each filter of the filter wheel can be determined from the position determining mechanism of the corresponding drive motor and filter position determining devices 150. In such a case, the control device 170 (FIG. 9) is further configured and arranged so as to relate the video signals to the corresponding filter 122, 124 or filter section of each filter wheel 120a,b. Alternatively, the control-device 170 relates the video signals to the corresponding filter 122, 124 or filter section of one of the filter wheels.

In an illustrative embodiment, one of the filter wheels 120a,b is configured so as to include one filter or filter section and an aperture. The filter or filter section of said one of the filter wheels is provided to further filter the incoming light from the object or scene 2. For example, the filter or filter section of the said one of the filter wheels 120a,b is composed so as to filter infrared light. Further, and in a more specific embodiment, the two filter wheels 120a,b are configured and arranged so that this filter or filter section of said one of the filter wheels is disposed to further filter light to or from a red filter of the other of the filter wheels.

There is shown in FIG. 13, a diagrammatic view of a display portion of a video imaging apparatus according to the present invention. In the illustrated embodiment, an RGB television-type of display 200 is connected to the control device 170 via the output cable 190 so that the video signals corresponding to the different filters of the filter wheel 120 are integrated or merged so the image represented by these video signals is appropriately display on the image display 300 of the television-type of display 200, the displayed image being a color image.

Other modifications of the invention will occur to those in the art within the spirit and scope of the invention. Hence, the invention is not to be construed as limited to the particular embodiments discussed and shown in the figures. Thus, and although particular embodiments of the invention have been described using specific terms, such description is for illustrative purposes only, and it is to be understood that changes and variations may be made without departing from the spirit or scope of the following claims.

1. A video-imaging apparatus comprising:
an electro-optical viewing device including a plurality of filters selectively positioned at a light input end of the electro-optical viewing device;
a video imaging device positioned at a light output end of the electro-optical viewing device, that outputs video signals corresponding to light coming from the light output end;
a filter determining mechanism that determines which of the plurality of filters is disposed at the light input end for particular light coming from the light output end and that provides an output signal of the determined filter;
a display device that processes the video signals and the output signal of the determined filter so that a color image is displayed on a display of the display device.

2. The apparatus of claim 1, where each of the plurality of filters is configured so as to filter different band passes.

3. The apparatus of claim 3, wherein the plurality of filters filter light in the visible and/or infrared ranges.

4. The apparatus of claim 1, wherein the electro-optical viewing device has a substantially monochromatic output in the absence of the filters.

5. The device of claim 1, wherein the electro-optical viewing device is a night vision device.

6. The apparatus of claim 1, wherein the plurality of filters are selectively rotated at the light input end during use.

7. The device of claim 1, wherein the plurality of filters are configured and arranged so as to form a first set of filters and wherein said first set is connected to a shaft that runs substantially parallel to an optical axis of the electro-optical viewing device.

8. The apparatus of claim 7 wherein the shaft rotates or oscillates during use of the device.

9. The apparatus of claim 7, wherein the first set of filters rotate by manual action.

10. The apparatus of claim 7 wherein the first set of filters rotate by a motorized system.

11. The apparatus of claim 1, wherein the plurality of filters are mounted on a first wheel, and the first wheel rotates in a direction substantially perpendicular to the electro-optical viewing device optical axis during use.

12. The apparatus of claim 1, wherein the plurality of filters comprises at least two filter elements, each element being a different color.

13. The apparatus of claim 12 wherein a first filter element is red and a second filter element is one of green or blue.

14. The apparatus of claim 12, further comprising three filter elements, where a first filter element is red, a second filter element is green and a third filter element is blue.

15. The apparatus of claim 1, wherein said plurality of filters comprises first and second filters, each of the first and second filters being disposed at the input end of the electro-optical viewing device such that incoming light from an object or scene being viewed successively passes through the first and second filters.

16. The apparatus of claim 15, wherein the first and second filters are each rotated in a direction substantially perpendicular to the electro-optical viewing device optical axis during use.

17. A method of converting a monochromatic light to portray a full-color video image, comprising the steps of:
viewing a scene with a viewing device having a light input end and a light output end;
selectively and repetitively filtering light to the light input end of the viewing device using a plurality of filters;
viewing the light coming from the output end of the viewing device and outputting signals corresponding to the light coming from the light output end;
determining which of the plurality of filters is disposed at the light input end for particular light coming form the light output end of the viewing device; and
creating a color image of the scene being viewed using the signals being outputted corresponding to the light coming from the light output end and the determination of which filter is disposed at the light input end.

18. The conversion method of claim 17 further comprising the step of displaying the created color image of the scene.

19. The method of claim 17 wherein the plurality of filters for said selectively and repetitively filtering are configured so as to filter different band passes.

20. The method of claim 17 wherein:
said selectively and repetitively filtering includes one of rotating or oscillating each of the plurality of filters past the light input each of the viewing device.

21. The method of claim 17 wherein:
said plurality of filters includes a plurality of sets of filters, each set comprising at least one filter;
wherein said selectively and repetitively filtering light includes selectively and repetitively filtering light incoming from the scene so the incoming light successfully passes through each set of filters; and
wherein said determining includes determining which of the filters comprising one of the plurality of sets of filters is disposed at the light input end of the viewing device.
